(19) United States
(12) Patent Application Publication
(10) Pub. No.: US 2026/0217976 A1
(43) Pub. Date: Jul. 30, 2026

(54) POLYDIENES AND POLYDIENE COPOLYMERS WITH POLY(ALKYLENE OXIDE) GRAFTS AND THE USE OF THE SAME IN THE MANUFACTURE OF TIRE COMPONENTS

(71) Applicant: Bridgestone Corporation, Tokyo (JP)

(72) Inventors: Rita E. COOK, Akron, OH (US); Erin SHEEPWASH, Copley, OH (US)

(21) Appl. No.: 19/145,672

(22) PCT Filed: Jan. 3, 2024
(86) PCT No.: PCT/US2024/010118

§ 371 Date: Jul. 3, 2025

Related U.S. Application Data
(60) Provisional application No. 63/478,216, filed on Jan. 3, 2023.

(51) Int. Cl. C08L 87/00; B60C 1/00; C08G 81/02

(52) U.S. Cl. CPC C08L 87/005; B60C 1/0016; C08G 81/025

(57) ABSTRACT

A tire tread comprising the vulcanized residue of a vulcanizable composition including (i) a poly(alkylene oxide) grafted polydiene or polydiene copolymers; (ii) a natural or synthetic elastomer; (iii) silica filler; and (vi) a curative, where the poly(alkylene oxide) grafted polydiene or polydiene copolymers includes a sulfur or methacrylate linkage between a polydiene or polydiene copolymer chain and a poly(alkylene oxide) chain.

### FIELD OF THE INVENTION

Embodiments of the invention are directed toward the preparation of poly(alkylene oxide) grafted polydiene and polydiene copolymers and the use of these polymers in the manufacture of tire components, particularly silica-filled tire components.

### BACKGROUND OF THE INVENTION

In the art of making tires, silica is often used as a reinforcing filler because it offers increased mechanical strength and lowers rolling resistance. The use of silica as a reinforcing filler, however, can be problematic because silica is generally incompatible with tire rubber and it tends to agglomerate. The latter is believed to impact the ability of the tire to resist wear and abrasion. There is therefore a need to increase the compatibility between silica and the other constituents of the rubber compound, especially the rubber component.

### SUMMARY OF THE INVENTION

One or more embodiments of the present invention provide a tire tread comprising the vulcanized residue of a vulcanizable composition including (i) a poly(alkylene oxide) grafted polydiene or polydiene copolymers; (ii) a natural or synthetic elastomer; (iii) silica filler; and (vi) a curative, where the poly(alkylene oxide) grafted polydiene or polydiene copolymers includes a sulfur or methacrylate linkage between a polydiene or polydiene copolymer chain and a poly(alkylene oxide) chain.

Yet other embodiments of the present invention provide a method for preparing a poly(alkylene oxide) grafted polydiene or polydiene copolymer, the method comprising (i) providing a polydiene or polydiene copolymer; (ii) providing an end-functionalized poly(alkylene oxide); (iii) combining the polydiene or polydiene copolymer with the end-functionalized poly(alkylene oxide) within a solvent; (iv) allowing the polydiene or polydiene copolymer to react with the end-functionalized poly(alkylene oxide) in the presence of a free-radical initiator to thereby form a poly(alkylene oxide) grafted polydiene or polydiene copolymer including a polydiene or polydiene copolymer with a one or more poly(alkylene oxide) chains grafter thereto.

### DETAILED DESCRIPTION OF ILLUSTRATIVE EMBODIMENTS

Embodiments of the invention are based, at least in part, on the discovery of a method to prepare poly(alkylene oxide) grafted polydiene and polydiene copolymers, as well as their use in the manufacture of silica-filled tire components, such as treads. In particular embodiments, the polymers are poly(ethylene glycol) grafted poly(styrene-co-butadiene) copolymers. It has been unexpectedly discovered that silica-filled tire components, such as treads, prepared using these grafted copolymers demonstrate an advantageous balance of rolling resistance and dry handling as indicated by the dynamic properties of the vulcanizate.

### Preparation of Grafted Copolymers

In one or more embodiments, the poly(alkylene oxide) grafted polydiene and polydiene copolymers (e.g. poly(ethylene glycol) grafted poly(styrene-co-butadiene) copolymers), which may be referred to as PEG grafted polydienes or copolymers or simply grafted polymers, are prepared by combining a polydiene or polydiene copolymers (e.g. poly(styrene-co-butadiene) copolymer) with an end-functionalized poly(ethylene glycol) in the presence of a free-radical initiator within a suitable solvent or liquid medium.

### Reaction Conditions

### Time

As suggested above, the polydiene or polydiene copolymer (e.g. poly(styrene-co-butadiene) copolymer) is combined with an end-functionalized poly(alkylene oxide) in the presence of a free-radical initiator within a suitable solvent or liquid medium, which collectively may be referred to as the reaction mixture. It is believed that the end-functionalized poly(alkylene oxide) reacts with vinyl units on the polydiene or polydiene copolymer to form the grafted polymer. Following the reaction, the reaction mixture is optionally quenched and then the grafted polymer is isolated from the other constituents of the reaction mixture.

According to one or more embodiments of the present invention, the reactants are combined (i.e. the polydiene and/or polydiene copolymer is combined with the end-functionalized poly(alkylene oxide)) and are maintained with the reaction mixture for at least 10 hours, in other embodiments for at least 12 hours, and in other embodiments for at least 15 hours before isolating the grafted polymer. In these or other embodiments, the reactants are combined (i.e. the polydiene and/or polydiene copolymer is combined with the end-functionalized poly(alkylene oxide)) and are maintained within the reaction mixture for from about 10 to about 25 hours, in other embodiments from about 12 to about 20 hours, and in other embodiments from about 15 to about 17 hours before isolating the grafted polymer.

### Temperature and Reaction Conditions

In one or more embodiments, the reaction mixture in which the end-functionalized poly(alkylene oxide) is reacted with the polydiene or polydiene copolymer to form the grafted polymer may be maintained at a temperature sufficient to activate the free radical initiator. In one or more embodiments, the reaction mixture is maintained at temperature of from about 65 to about 100° C., in other embodiments from about 70 to about 98° C., or in other embodiments from about 80 to about 95° C.

In one or more embodiments, the reaction mixture is maintained under an inert atmosphere; e.g. under a nitrogen blanket within a sealed container. As those skilled in the art appreciate, the pressure under which the reaction mixture is maintained will increase as the temperature of the reaction mixture increases.

### Solids Concentration

In one or more embodiments, the reaction mixture in which the end-functionalized poly(alkylene oxide) is reacted with the polydiene or polydiene copolymer to form the grafted polymer, which as noted above includes a solvent or liquid medium, may be characterized by a solids concentration of less than 20, in other embodiments less than 18, and in other embodiments less than 15 wt % of the polymerization mixture. In one or more embodiments, the reaction mixture includes from about 8 to about 20, in other embodiments from about 10 to about 18, and in other embodiments from about 11 to about 15 wt % solids, based on the entire weight of the polymerization mixture.

### Polydiene and Polydiene Copolymers

The polydiene or polydiene copolymers that are grafted in accordance with embodiments of the present invention are generally characterized by including one or more mer units deriving from the polymerization of diene monomer and optionally one or more units deriving from the polymerization of vinyl aromatic monomer. In particular embodiments, the polymer that is grafted is a polydiene copolymer that includes mer units deriving from diene monomer and vinyl aromatic monomer. In one or more embodiments, the polymer that is grafted is a poly(styrene-co-butadiene) copolymer.

The polydiene or polydiene copolymers may be characterized by their molecular weight, which may include number average molecular weight (Mn), weight average molecular weight (Mw), and peak molecular weight (Mp). As those skilled in the art will appreciate, molecular weight can be determined by using gel permeation chromatography (GPC) using appropriate calibration standards. For purposes of this specification, GPC measurements employ polystyrene standards and polystyrene Mark Houwink constants unless otherwise specified.

In one or more embodiments, the polydiene or polydiene copolymers have an Mp, which may also be referred to as the base Mp, of greater than 160 kg/mol, in other embodiments greater than 170 kg/mol, and in other embodiments greater than 180 kg/mol. In these or other embodiments, the polydiene or polydiene copolymers have an Mp of less 280 kg/mol, in other embodiments less than 260 kg/mol, and in other embodiments less than 250 kg/mol. In one or more embodiments, the polydiene or polydiene copolymers have an Mp of from about 160 to about 280 kg/mol, in other embodiments from about 170 to about 260 kg/mol, and in other embodiments from about 180 to about 250 kg/mol.

In one or more embodiments, the polydiene or polydiene copolymers have an Mn, which may also be referred to as the base Mn, of greater than 130 kg/mol, in other embodiments greater than 140 kg/mol, and in other embodiments greater than 150 kg/mol. In these or other embodiments, the polydiene or polydiene copolymers have an Mn of less 300 kg/mol, in other embodiments less than 280 kg/mol, and in other embodiments less than 260 kg/mol. In one or more embodiments, the polydiene or polydiene copolymers have an Mn of from about 130 to about 300 kg/mol, in other embodiments from about 140 to about 280 kg/mol, and in other embodiments from about 150 to about 260 kg/mol.

In one or more embodiments, the polydiene or polydiene copolymers have an Mw, which may also be referred to as the base Mw, of greater than 180 kg/mol, in other embodiments greater than 190 kg/mol, and in other embodiments greater than 200 kg/mol. In these or other embodiments, the polydiene or polydiene copolymers have an Mw of less 500 kg/mol, in other embodiments less than 450 kg/mol, and in other embodiments less than 400 kg/mol. In one or more embodiments, the polydiene or polydiene copolymers have an Mw of from about 180 to about 500 kg/mol, in other embodiments from about 190 to about 450 kg/mol, and in other embodiments from about 200 to about 400 kg/mol.

The polydiene or polydiene copolymers produced according to aspects of the present invention may be characterized by vinyl content, which may be described as the number of unsaturations in the 1,2-microstructure relative to the total unsaturations within the polymer chain. As the skilled person will appreciate, vinyl content can be determined by NMR analysis. In one or more embodiments, the polydiene or polydiene copolymers include greater than 10%, in other embodiments greater than 20%, and in other embodiments greater than 35% vinyl. In these or other embodiments, the polydiene or polydiene copolymers include less than 80%, in other embodiments less than 60%, and in other embodiments less than 46%. In one or more embodiments, the reactive polymers include from about 10 to about 80%, in other embodiments from about 20 to about 60%, and in other embodiments from about 35 to about 46% vinyl.

The polydiene or polydiene copolymers produced according to aspects of the present invention may be characterized by bound styrene content, which refers to the weight percent vinyl aromatic monomer incorporated into polydiene copolymers. As the skilled person appreciates, bound styrene (i.e. styrene incorporated in the polymer) can be determined with reference to the relative weight of vinyl monomer included into the polymerization mixture relative to the diene monomer. Alternatively, bound styrene can be determined by NMR analysis. In one or more embodiments, the polydiene or polydiene copolymers include greater than 5 wt %, in other embodiments greater than 8 wt %, and in other embodiments greater than 10 wt % vinyl content. In these or other embodiments, the reactive copolymers include less than 50 wt %, in other embodiments less than 35 wt %, and in other embodiments less than 20 wt % vinyl content. In one or more embodiments, the reactive copolymers include from about 5 to about 50 wt %, in other embodiments from about 5 to about 20 wt %, in other embodiments from about 8 to about 15 wt %, and in other embodiments from about 10 to about 20 wt % vinyl content.

### End-Functionalized Poly(Alkylene Oxide)

In one or more embodiments, the end-functionalized poly(alkylene oxide) that is grafted to the polydienes or polydiene copolymers in accordance with embodiments of the present invention includes one or more mer units deriving from the polymerization of alkylene oxide monomer, and it also includes a terminal functional group that will react with a vinyl unit of the polydiene or polydiene copolymer under appropriate conditions as described herein.

In one or more embodiments, the alkylene oxide monomer from which the poly(alkylene oxide) chain of the end-functionalized poly(alkylene oxide) is formed may be selected from ethylene oxide and propylene oxide. In particular embodiments, the chain is a polyethylene oxide, which may also be referred to as a polyethylene glycol, ethylene glycol, PEO, or PEG chain.

The poly(alkylene oxide) chain, which may also be referred to as a poly(alkylene oxide) group, is characterized by the number of mer (also referred to as repeat units) within the chain. In one or more embodiments, the poly(alkylene oxide) chain includes from about 5 to about 55, in other embodiments from about 8 to about 50, and in other embodiments from about 10 to about 45 repeat units. In one or more embodiments, the poly(alkylene oxide) group includes less than 25, in other embodiments less than 20, in other embodiments less than 15, in other embodiments less than 12, and in other embodiments less than 10 repeat units.

In one or more embodiments, the chain length of the poly(alkylene oxide) group may vary depending on whether the group is associated with poly(alkylene oxide) with an end thiol group or a poly(alkylene oxide) with an end methacrylate group. For example, where the poly(alkylene oxide) group is associated an end thiol group, the number of repeat units may be from about 30 to about 55, in other embodiments from about 35 to about 50, and in other embodiments from about 40 to about 45 repeat units. On the other hand, where the poly(alkylene oxide) group is associated with poly(alkylene oxide) with an end methacrylate group, the number of repeat units may be from about 5 to about 20, in other embodiments from about 7 to about 15, and in other embodiments from about 8 to about 12 repeat units.

In these or other embodiments, the poly(alkylene oxide) chain may be characterized by its molecular weight. In one or more embodiments, the poly(alkylene oxide) chain has a number average molecular weight (Mn) of from about 250 to about 5000 g/mol, in other embodiments from about 400 to about 2500 g/mol, and in other embodiments from about 500 to about 2000 g/mol. In one or more embodiments, the poly(alkylene oxide) group has an Mn of less than 1500, in other embodiments less than 1250, in other embodiments less than 1000, in other embodiments less than 750, and in other embodiments less than 500 g/mol.

In one or more embodiments, the molecular weight of the poly(alkylene oxide) group may vary depending on whether the group is associated with poly(alkylene oxide) with an end thiol group or a poly(alkylene oxide) with an end methacrylate group. For example, where the poly(alkylene oxide) group is associated with an end thiol group, the Mn may be from about 1000 to about 5000, in other embodiments from about 1500 to about 3000, and in other embodiments from about 1700 to about 2250 g/mol. On the other hand, where the poly(alkylene oxide) group is associated with poly(alkylene oxide) with an end methacrylate group, the Mn may be from about 250 to about 1500, in other embodiments from about 400 to about 1000, and in other embodiments from about 450 to about 750 g/mol.

As indicated above, the end-functionalized poly(alkylene oxide) includes a terminal functional group that will react with a vinyl unit of the polydiene or polydiene copolymer. In one or more embodiments, the functional group includes a methacrylate group, and the end-functionalized poly(alkylene oxide) may be referred to as methacrylate-terminated poly(alkylene oxide) or poly(alkylene oxide) methacrylate. In other embodiments, the functional group includes a thiol group, which may also be referred to as a sulfanyl group, and the end-functionalized poly(alkylene oxide) may be referred to as a thiol-terminated poly(alkylene oxide) or poly(alkylene oxide) thiol.

In one or more embodiments, the methacrylate group may be defined by the formula —O—C(O)—C(CH3)=CH2. In other words, the end-functionalized poly(alkylene oxide) including a terminal methacrylate group can be defined by the formula R10-O—C(O)—C(CH3)=CH2, where R10 is a poly(alkylene oxide) group. Poly(alkylene oxide) polymers functionalized with a terminal methacrylate group are commercially available. For example, methacrylate end-functionalized poly(ethylene oxide) polymers having a molecular weight of about 550 g/mole can be purchased under the tradenames PSB-2162 from Creative PEGWorks, or polymers having a molecular weight of about 500 g/mole can be purchased from Sigma Aldrich.

In one or more embodiments, the thiol group may be defined by the formula —SH. In other words, the end-functionalized poly(alkylene oxide) including a terminal thiol group can be defined by the formula R10-SH, where R10 is a poly(alkylene oxide) group. Poly(alkylene oxide) polymers functionalized with a terminal thiol group are commercially available. For example, thiol end-functionalized poly(ethylene oxide) polymers having a molecular weight of about 2000 g/mole can be purchased under the tradenames PLS-605 from Creative PEGWorks, or thiol end-functionalized poly(ethylene oxide) polymers having a molecular weight of about 2000 g/mole can be purchased from LaysanBio.

In one or more embodiments, the end-functionalized poly(ethylene oxide) polymers used in the present invention are mono-functional, which refers to the fact that the polymer include only one functional group at one end of the polymer chain. In these or other embodiments, the poly(ethylene oxide) chain is a linear chain, the other end of the chain is capped, which refers to the fact that the other end of the chain includes, for example, an alkyl unit, which forms an alkoxide end group (i.e. —O—R). For example, the poly(alkylene oxide) end of the chain not tethered to the functional group may include a methyl group and therefore may be referred to as methoxy poly(alkylene oxide).

### Reactant Amounts

The amount of the end-functionalized poly(alkylene oxide) that is combined with the polydiene or polydiene copolymer within the reaction mixture to form the grafted polymer may be quantified based upon the molar ratio of the moles of end-functionalized poly(alkylene oxide) to the moles of polydiene or polydiene copolymer. Alternatively, the amount of the end-functionalized poly(alkylene oxide) that is combined with the polydiene or polydiene copolymer within the reaction mixture to form the grafted polymer may be quantified based upon the relative weight of the end-functionalized poly(alkylene oxide) to the weight of polydiene or polydiene copolymer. In either event, the amount of end-functionalized poly(alkylene oxide) reacted with the polydiene or polydiene copolymer may depend on the reactivity of the end-functionalized poly(alkylene oxide). It has been observed that that the poly(alkylene oxide) with an end thiol group is more reactive than the poly(alkylene oxide) with an end methacrylate group. Accordingly, in one or more embodiments, the poly(alkylene oxide) with an end methacrylate group may be added in greater excess.

In one or more embodiments, where the end-functionalized poly(alkylene oxide) includes a methacrylate group, the molar ratio of moles of the end-functionalized poly(alkylene oxide) to the moles of polydiene or polydiene copolymer may be from about 30:1 to about 50:1, in other embodiments from about 33:1 to about 45:1, and in other embodiments from about 35:1 to about 42:1.

In one or more embodiments, where the end-functionalized poly(alkylene oxide) includes a thiol group, the molar ratio of moles of the end-functionalized poly(alkylene oxide) to the moles of polydiene or polydiene copolymer may be from about 1:1 to about 10:1, in other embodiments from about 1.3:1 to about 8:1, and in other embodiments from about 1.5:1 to about 6:1.

In one or more embodiments, where the end-functionalized poly(alkylene oxide) includes a methacrylate group (e.g. the poly(alkylene oxide) having an Mn of about 500), the relative weight of the end-functionalized poly(alkylene oxide) to the weight of polydiene or polydiene copolymer may be from about 10 to about 20 parts by weight, or in other embodiments from about 12 to about 18 parts by weight, or in other embodiments from about 14 to about 16 parts by weight of the end-functionalized poly(alkylene oxide) per 100 parts by weight of the polydiene or polydiene copolymer.

In one or more embodiments, where the end-functionalized poly(alkylene oxide) includes a thiol group (e.g. the poly(alkylene oxide) having an Mn of about 2000), the relative weight of the end-functionalized poly(alkylene oxide) to the weight of polydiene or polydiene copolymer may be from about 1 to about 15 parts by weight, or in other embodiments from about 2 to about 12 parts by weight, or in other embodiments from about 3 to about 11 parts by weight of the end-functionalized poly(alkylene oxide) per 100 parts by weight of the polydiene or polydiene copolymer.

### Free-Radical Initiator

As indicated above, free-radical initiators are employed to promote the reaction between the polydiene or polydiene copolymers and the end-functionalized poly(alkylene oxide). In one or more embodiments, the free-radical initiator is soluble within the reaction mixture and is activated upon heating. In one or more embodiments, the free-radical initiator is activated upon heating to temperatures consistent with the reaction temperatures outlined above.

In one or more embodiments, the free-radical initiator is an azo compound such as, but not limited to, azobisisobutyronitrile (i.e. 2,2′-azobis(2-methylpropionitrile)) (also known as AIBN), 1,1′-azobis(cyclohexanecarbonitrile), 2,2′-azobis(2,4-dimethylvaleronitrile), and dimethyl-2,2′-azobis(2-methylpropionate).

As the skilled person readily recognizes, the amount of free-radical initiator that can be employed depends on the nature of the free-radical initiator, and a person of skill in the art can readily determine an appropriate amount to use with undue experimentation. In one or more embodiments, the amount of free-radical initiator present within the reaction mixture can be quantified relative to the end-functionalized poly(alkylene oxide). For example, where the free-radical initiator is AIBN, in one or more embodiments, the amount of free-radical initiator present within the reaction mixture is from about 0.05 to about 0.5, in other embodiments from about 0.07 to about 0.3, and in other embodiments from about 0.1 to about 0.2 parts by weight AIBN per 100 parts of the end-functionalized poly(alkylene oxide).

### Reaction Medium

As noted above, the reaction mixture includes a solvent, which may also be referred to as the reaction medium. In one or more embodiments, at least one of the polydiene or polydiene copolymers, the end-functionalized poly(alkylene oxide), and the grafted polymer product are soluble in the solvent. In one or more embodiments, each of the polydiene or polydiene copolymers, the end-functionalized poly(alkylene oxide), the free-radical initiator, and the grafted polymer product are soluble in the solvent.

Useful solvents include, but are not limited to, hydrocarbons with a low or relatively low boiling point such as aromatic hydrocarbons, aliphatic hydrocarbons, and cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. And, non-limiting examples of cycloaliphatic hydrocarbons include cyclopentane, cyclohexane, methylcyclopentane, and methylcyclohexane. Mixtures of the above hydrocarbons may also be used.

### Antioxidant

In one or more embodiments, after the grafting reaction, optionally after the addition of a quenching agent, which is discussed below, or in combination with the quenching agent, an antioxidant can be introduced to the reaction mixture. Exemplary antioxidants include 2,6-di-tert-butyl-4-methylphenol (also known as BHT).

As the skilled person understands, the effective amount of antioxidant can vary depending on the nature of the antioxidant, and a person of skill in the art can readily determine an appropriate amount with undue experimentation. For example, where BHT is employed, the amount of antioxidant introduced the reaction mixture may be from about 0.1 to about 1.0, or in other embodiments from about 0.5 to about 0.7 parts by weight AIBN per 100 parts of the end-functionalized poly(alkylene oxide).

### Quenching of Reaction

Following the reaction between the polydiene or polydiene copolymers and the end-functionalized poly(alkylene oxide), the reaction mixture may be quenched, which inactivates the reactivity caused by the free-radical initiator. In one or more embodiments, the quenching agent may include a protic compound, which includes, but is not limited to, an alcohol, a carboxylic acid, an inorganic acid, water, or a mixture thereof.

As the skilled person appreciates, an excess amount of quenching agent can be efficiently used.

### Grafted Polymer Desolventization

Following the grafting reaction and optional introduction of a quenching agent, and optional introduction of an antioxidant, the grafted polymer product can be separated from the solvent, which may be referred to as desolventization. In other words, as described above, the grafting reaction takes place in an organic solvent, and during the step of desolventization, the organic solvent is separated from the resulting grafted polymer.

In particular embodiments, desolventization includes hot water and/or steam coagulation. For example, the reaction mixture, which includes the grafted polymer, can be combined with a steam or hot water stream. The heat associated with the steam or hot water stream volatilizes the solvent and any other volatiles within the reaction mixture. The polymer product is then dispersed within an aqueous phase in, for example, the form of polymer crumb. The nature and size of the polymer crumb can generally be manipulated by the introduction of mechanical energy (e.g., in the form of mixers).

In one or more embodiments, the polymer crumb is temporarily stored as a crumb dispersion within the water until subsequent drying steps, which are described below. The crumb dispersion is generally a mixture of polymer particles or crumb and water. The polymer particles, which may also be referred to as coagulated polymer, are generally on the macroscale and have at least on dimension that is greater than one millimeter. This crumb dispersion may be contained within a tank, such as a conventional reactor tank such as a continuously stirred tank reactor.

In one or more embodiments, the polymer crumb can be further processed to remove residual solvent and dry the polymer (i.e., separate the polymer from the water). In practicing the present invention, the polymer can be dried by using conventional techniques, which may include one or more of filtering, pressing, and heating. Following desolventization and drying, the volatile content of the dried polymer can be below 2.0%, in other embodiments below 1.0%, and in other embodiments below 0.5% by weight of the polymer.

In other embodiments, the grafted polymer product can be desolventized by employing devolatilizers, which are extruder-type devices that can operate in conjunction with heat and/or vacuum. In yet other embodiments, the reaction mixture can be directly drum dried. In yet other embodiments, the reaction product can be dried by heating the same on a heated mill.

Regardless of the methods used to desolventize and dry the grafted polymer, the finished polymer product may be referred to as a dried polymer. Using conventional techniques, the dried polymer can be molded or otherwise manipulated into a bale.

### Characteristics of Grafted Polymers

In one or more embodiments, the grafted polymers may be characterized by weight percentage of the poly(alkylene oxide) associated with the grafted polymer. As the skilled person will appreciate, this weight percentage can be determined by NMR analysis. In one or more embodiments, the grafted polymers include greater than 1, in other embodiments greater than 2, and in other embodiments greater than 3 wt % poly(alkylene oxide). In one or more embodiments, the grafted polymers include from about 1 to about 10, in other embodiments from about 1.3 to about 8, and in other embodiments from about 1.5 to about 7.5 wt % poly(alkylene oxide).

In one or more embodiments, the grafted polymers may be characterized by the number of the poly(alkylene oxide) grafts (i.e. poly(alkylene oxide chains) associated with the overall grafted polymer. As the skilled person will appreciate, this can also be determined by NMR analysis. In one or more embodiments, the number of grafts associated with the grafted polymers may be greater than 1, in other embodiments greater than 2, and in other embodiments greater than 3, and in other embodiments greater than 4. In one or more embodiments, the number of grafts associated with the grafted polymers may be from about 1 to about 12, in other embodiments from about 2 to about 10, and in other embodiments from about 3 to about 9. In one or more embodiments, the number of grafts may vary depending on the nature of the end-functionalized poly(alkylene oxide). For example, where the end-functionalized poly(alkylene oxide) has an end thiol group, the number of grafts may be from about 1 to about 6, in other embodiments from about 1.3 to about 7, and in other embodiments from about 1.5 to about 5. On the other hand, where the poly(alkylene oxide) has an end methacrylate group, the number of grafts may be from about 2 to about 10, in other embodiments from about 3 to about 8, and in other embodiments from about 4 to about 6.

In one or more embodiments, where the grafted polymer is synthesized by reacting an end-functionalized poly(alkylene oxide) including a terminal methacrylate with a polydiene or polydiene copolymer, the grafted polymer may be characterized by including a methacrylate graft (also referred to as a linkage) between the polydiene or polydiene copolymer and the poly(alkylene oxide) chain. In those embodiments where the grafted polymer is synthesized by reacting an end-functionalized poly(alkylene oxide) including a terminal thiol group with a polydiene or polydiene copolymer, the grafted polymer may be characterized by including a sulfur graft (also referred to as a linkage) between the polydiene or polydiene copolymer and the poly(alkylene oxide) chain.

### INDUSTRIAL APPLICABILITY

In one or more embodiments, the grafted polymers of the invention may be used in formulating vulcanizable rubber composition that may, for example, be useful in the preparation of tire components. Rubber compounding techniques and the additives employed therein are generally disclosed in The Compounding and Vulcanization of Rubber, in Rubber Technology (2^{nd} Ed. 1973).

Generally speaking, these vulcanizable rubber compositions include a vulcanizable rubber component, reinforcing filler, and a curative or curative system. These compositions may also optionally include metal activators, resins, and processing oils, as well the various ingredients that may be conventionally included in these vulcanizable rubber compositions.

In one or more embodiments, the grafted polymers of this invention may form all or part of the rubber component of the vulcanizable compositions. That is, the rubber component may include other vulcanizable rubbers, which may also be referred to as elastomeric polymers or simply elastomers.

### Other Elastomers of Rubber Component

The rubber compositions can be prepared by using the polymers of this invention alone or together with other elastomers (i.e., polymers that can be vulcanized to form compositions possessing rubbery or elastomeric properties). Other elastomers that may be used include natural and synthetic rubbers. The synthetic rubbers typically derive from the polymerization of conjugated diene monomers, the copolymerization of conjugated diene monomers with other monomers such as vinyl-substituted aromatic monomers, or the copolymerization of ethylene with one or more α-olefins and optionally one or more diene monomers.

Exemplary elastomers include natural rubber, synthetic polyisoprene, polybutadiene, polyisobutylene-co-isoprene, neoprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched, and star-shaped structures.

The rubber compositions may include fillers such as inorganic and organic fillers. Examples of organic fillers include carbon black and starch. Examples of inorganic fillers include silica, aluminum hydroxide, magnesium hydroxide, mica, talc (hydrated magnesium silicate), and clays (hydrated aluminum silicates). Carbon blacks and silicas are the most common fillers used in manufacturing tires. In certain embodiments, a mixture of different fillers may be advantageously employed.

For purposes of this specification, the poly(alkylene oxide) grafted polydiene or polydiene copolymers are considered part of the rubber component of the vulcanizable compositions. In one or more embodiments, the vulcanizable compositions include from about 40 to about 70 wt %, in other embodiments from about 45 to about 65 wt %, and in other embodiments from about 50 to about 60 wt % rubber based upon the entire weight of the vulcanizable composition. In one or more embodiments, the rubber component includes from about 30 to about 100 wt %, in other embodiments from about 50 to about 90 wt %, and in other embodiments from about 60 to about 80 wt % of the poly(alkylene oxide) grafted polydiene or polydiene copolymers based upon the total weight of the rubber component. In these or other embodiments, the rubber component includes greater than 50 wt %, in other embodiments greater than 60 wt %, in other embodiments greater than 70 wt %, and in other embodiments greater than 80 wt % of the poly(alkylene oxide) grafted polydiene or polydiene copolymers based upon the total weight of the rubber component.

In one or more embodiments, carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In particular embodiments, the carbon blacks may have a surface area (EMSA) of at least 20 m²/g and in other embodiments at least 35 m²/g; surface area values can be determined by ASTM D-1765 using the cetyltrimethylammonium bromide (CTAB) technique. The carbon blacks may be in a pelletized form or an unpelletized flocculent form. The preferred form of carbon black may depend upon the type of mixing equipment used to mix the rubber compound.

The amount of carbon black employed in the rubber compositions can be up to about 50 parts by weight per 100 parts by weight of rubber (phr), with about 5 to about 40 phr being typical.

Some commercially available silicas which may be used include Hi-Sil™ 215, Hi-Sil™ 233, and Hi-Sil™ 190 (PPG Industries, Inc.; Pittsburgh, Pa.). Other suppliers of commercially available silica include Grace Davison (Baltimore, Md.), Degussa Corp. (Parsippany, N.J.), Rhodia Silica Systems (Cranbury, N.J.), and J. M. Huber Corp. (Edison, N.J.).

In one or more embodiments, silicas may be characterized by their surface areas, which give a measure of their reinforcing character. The Brunauer, Emmet and Teller (“BET”) method (described in J. Am. Chem. Soc., 1939, vol. 60, 2 p. 309-319) is a recognized method for determining the surface area. The BET surface area of silica is generally less than 450 m²/g. Useful ranges of surface area include from about 32 to about 400 m²/g, about 100 to about 250 m²/g, and about 150 to about 220 m²/g.

The pH's of the silicas are generally from about 5 to about 7 or slightly over 7, or in other embodiments from about 5.5 to about 6.8.

In one or more embodiments, where silica is employed as a filler (alone or in combination with other fillers), a coupling agent and/or a shielding agent may be added to the rubber compositions during mixing in order to enhance the interaction of silica with the elastomers. Useful coupling agents and shielding agents are disclosed in U.S. Pat. Nos. 3,842,111; 3,873,489; 3,978,103; 3,997,581; 4,002,594; 5,580,919; 5,583,245; 5,663,396; 5,674,932; 5,684,171; 5,684,172; 5,696,197; 6,608,145; 6,667,362; 6,579,949; 6,590,017; 6,525,118; 6,342,552; and 6,683,135; which are incorporated herein by reference.

As indicated above, the grafted polymers of this invention are particularly advantageous in vulcanizates (e.g. tire treads) that include silica filler. In one or more embodiments, these vulcanizates are prepared from rubber compositions that includes greater than 50 parts by weight, in other embodiments greater than 65 parts by weight, and in other embodiments greater than 80 parts by weight silica per 100 parts by weight rubber. The useful upper range may be limited by the high viscosity imparted by silica. In one or more embodiments, these vulcanizates are prepared from rubber compositions that includes from about 70 to about 120 parts by weight, in other embodiments from about 80 to about 115 parts by weight, and in other embodiments from about 85 to about 110 parts by weight silica per 100 parts by weight rubber. Generally, silica is used in combination with a coupling agent and/or shielding, and the amount of coupling agent and/or shielding agent is from about 4% to about 20% based on the weight of silica used.

In one or more embodiments, silica is used together with carbon black. The amount of carbon black used in combination with silica can be quantified based upon a weight ratio of carbon black to silica. In one or more embodiments, the weight ratio of carbon black to silica is from about 0.1:1 to about 1:1, in other embodiments from about 0.15:1 to about 0.8:1, and in other embodiments from about 0.2:1 to about 0.5:1.

A multitude of rubber curing agents (also called vulcanizing agents) may be employed, including sulfur or peroxide-based curing systems. Curing agents are described in Kirk-Othmer, ENCYCLOPEDIA OF CHEMICAL TECHNOLOGY, Vol. 20, pgs. 365-468, (3rd Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2^{nd} Ed. 1989), which are incorporated herein by reference. Vulcanizing agents may be used alone or in combination.

Other ingredients that are typically employed in rubber compounding may also be added to the rubber compositions. These include accelerators, accelerator activators, oils, plasticizer, waxes, scorch inhibiting agents, processing aids, zinc oxide, tackifying resins, reinforcing resins, fatty acids such as stearic acid, peptizers, and antidegradants such as antioxidants and antiozonants. In particular embodiments, the oils that are employed include those conventionally used as extender oils, which are described above.

All ingredients of the rubber compositions can be mixed with standard mixing equipment such as Banbury or Brabender mixers, extruders, kneaders, and two-rolled mills. In one or more embodiments, the ingredients are mixed in two or more stages. In the first stage (often referred to as the masterbatch mixing stage), a so-called masterbatch, which typically includes the rubber component and filler, is prepared. To prevent premature vulcanization (also known as scorch), the masterbatch may exclude vulcanizing agents. The masterbatch may be mixed at a starting temperature of from about 25° C. to about 125° C. with a discharge temperature of about 135° C. to about 180° C. Once the masterbatch is prepared, the vulcanizing agents may be introduced and mixed into the masterbatch in a final mixing stage, which is typically conducted at relatively low temperatures so as to reduce the chances of premature vulcanization. Optionally, additional mixing stages, sometimes called remills, can be employed between the masterbatch mixing stage and the final mixing stage. One or more remill stages are often employed where the rubber composition includes silica as the filler. Various ingredients including the polymers of this invention can be added during these remills.

The mixing procedures and conditions particularly applicable to silica-filled tire formulations are described in U.S. Pat. Nos. 5,227,425; 5,719,207; and 5,717,022, as well as European Patent No. 890,606, all of which are incorporated herein by reference. In one embodiment, the initial masterbatch is prepared by including the polymer and silica in the substantial absence of coupling agents and shielding agents.

The rubber compositions prepared from the polymers of this invention are particularly useful for forming tire components such as treads, subtreads, sidewalls, body ply skims, bead filler, and the like. In one or more embodiments, these tread or sidewall formulations may include from about 10% to about 100% by weight, in other embodiments from about 35% to about 90% by weight, and in other embodiments from about 50% to about 80% by weight of the polymer of this invention based on the total weight of the rubber within the formulation.

Where the rubber compositions are employed in the manufacture of tires, these compositions can be processed into tire components according to ordinary tire manufacturing techniques including standard rubber shaping, molding and curing techniques. Typically, vulcanization is effected by heating the vulcanizable composition in a mold; e.g., it may be heated to about 140° C. to about 180° C. Cured or crosslinked rubber compositions may be referred to as vulcanizates, which are the sulfur-cured residue of the rubber composition (i.e. the vulcanizable composition) and which generally contain three-dimensional polymeric networks that are thermoset. The other ingredients, such as fillers and processing aids, may be evenly dispersed throughout the crosslinked network. Pneumatic tires can be made as discussed in U.S. Pat. Nos. 5,866,171; 5,876,527; 5,931,211; and 5,971,046, which are incorporated herein by reference.

### EXAMPLES

In order to demonstrate the practice of the present invention, the following examples have been prepared and tested. The examples should not, however, be viewed as limiting the scope of the invention. The claims will serve to define the invention.

### Polymer Example 1: SBR (Control)

A nitrogen purged jacketed steal reactor was charged with an approximately 20% by weight butadiene/hexanes mixture, an approximately 33% by weight styrene/hexanes mixture, and anhydrous hexanes sufficient to make 10 lbs. of a 15 wt. % solution of total monomers (1.5 wt % styrene, 13.5 wt % butadiene) in hexanes. The reactor was charged with n-butyllithium (1.6M in hexane, 0.714 mmol per hundred gram monomer), followed by 2,2-bis(2′-tetrahydrofuryl) propane (1.6 M in hexane, 0.30 eq. vs. Li) and the jacket temperature was set to 140° F. The batch temperature peaked at 189.6° F. after 24 minutes. After an additional 30 minutes, the polymerization was quenched by dropping the poly(styrene-co-butadiene) (SBR) polymer cement into a bucket containing about 8 L isopropyl alcohol (IPA) and 15 g of 2,6-di-tert-butyl-4-methylphenol (BHT). The polymer was coagulated and then drum dried. The polymer was analyzed by NMR to determine bound styrene and mole percent vinyl, based upon the diene units. The results of this testing is reported in Table I.

### Polymer Example 2: SBR-g-PEGM500

A batch of SBR cement was prepared as described in Example 1, except that the polymerization was quenched by the addition of isopropyl alcohol (1 eq. vs. Li) to the reactor. Thirty minutes after termination, and end-functionalized poly(ethylene oxide), namely methoxy poly(ethylene glycol) mono methacrylate (also referred to as poly(ethylene glycol) methyl ether methacrylate), which had an average Mn of 500 g/mole (PEGM500), with stabilizer removed by stirring over dry, basic alumina, was added to the reactor, followed by a free-radical initiator (i.e. 2,2′-azobis(2-methylpropionitrile) (AIBN) (0.1 eq. vs. PEGM500, dissolved in toluene), and the jacket temperature was set to 176° F. The amount of the SBR and PEGM500 introduced to the reactor are provided in Table I. After the reaction proceeded overnight, the reaction mixture (i.e. the polymer cement) was dropped into about 8 L isopropyl alcohol (IPA) and 15 g of 2,6-di-tert-butyl-4-methylphenol (BHT). The polymer was coagulated and then drum dried. The polymers were analyzed by NMR to determine bound styrene, mole percent vinyl, and weight percent ethylene oxide. The results of this testing are reported in Table I.

### Polymer Examples 3-4: SBR-g-PEGM500

The same procedure was followed as in Example 2, except that the jacket temperature was set to 200° F. for the overnight reaction. The resulting polymer was similarly isolated and analyzed. The results of the testing are reported in Table I.

TABLE I

| | Example 1 | | | |
|---|---|---|---|---|
| | (Control) | Example 2 | Example 3 | Example 4 |
| SBR (g) | 680 | 680 | 680 | 680 |
| PEGM500 (g) | — | 102 | 93 | 102 |
| AIBN (g) | — | 3.35 | 6.70 | 6.11 |
| Reaction time (hours) | — | 16 | 16.5 | 17 |
| % Styrene | 9.2 | 9.2 | 11.8 | 9.2 |
| % Vinyl (Bd = 100) | 36.9 | 37.9 | 37.5 | 35.9 |
| Wt % PEG | — | 1.6 | 2.2 | 2.5 |
| PEG Chains/SBR Chain | — | 3.9 | 5.5 | 6.2 |

### Polymer Examples 5-8: SBR-g-PEGSH

SBR was prepared in a manner similar to Example 1, the dried polymer was introduced to four dried 750 mL glass bottles. The bottles were then sealed with a rubber septum and purged with nitrogen, and about 450 mL of toluene was added. The polymer was allowed to dissolve overnight. End-functionalized poly(ethylene oxide), namely methoxy poly(ethylene glycol) mono thiol (also referred to as poly(ethylene glycol) methyl ether thiol (PEG-SH)), which had an average Mn of about 2000 g/mole was added to each bottle as a solid along with AIBN as a toluene solution. The amount of SBR, PEG-SH, and AIBN introduced to each bottle is reported in Table II. The bottles were agitated in an 80° C. water bath overnight, and then each bottle was quenched with 3 mL of an IPA/BHT solution (~0.1 g BHT/mL IPA solution) and poured into an IPA bucket (about 8 liters of IPA) containing BHT, coagulated and drum dried. The polymers were analyzed by NMR to determine bound styrene, mole percent vinyl, and weight percent ethylene oxide. The results of this testing are reported in Table II.

TABLE II

| | Example 5 | Example 6 | Example 7 | Example 8 |
|---|---|---|---|---|
| SBR (g) | 50 | 50 | 50 | 50 |
| PEG-SH (g) | 1.37 | 3.17 | 4.23 | 5.29 |
| AIBN (mg) | 11 | 26 | 35 | 52 |
| % Styrene | 11.2 | 12.1 | 10.9 | 11 |
| % Vinyl (Bd = 100) | 40.1 | 39.1 | 38.5 | 37.8 |
| Wt % PEG | 1.7 | 3.4 | 5.1 | 6.1 |
| PEG Chains/SBR chain | 1.1 | 2.2 | 3.3 | 4.0 |

### Rubber Examples 9-16

The polymers prepared in Examples 1-8 above were used to prepare silica-filled vulcanizable compositions by using the rubber formulation and mixing order provided in Table III. This rubber formulation was indicative of a rubber formulation that is useful in the manufacture of tire treads. As shown in Table III, the mix procedure was a three-step mix procedure including a masterbatch mix step, a “remill mix step,” and a final mix step. The various mixing steps were performed within a Brabender mixer. During preparation of the masterbatch, the mixer was operated at 50 rpm and a peak compositional temperature of 160° C. was attained. At that point in time, the composition was dropped from the mixer and allowed to cool to below about 90° C. At this point in time, the composition was then reintroduced to the mixer along with the ingredients identified for the “remill stage,” and mixing was continued at 50 rpm and a peak compositional temperature of about 160° C. was achieved. The composition was again dropped from the mixer and allowed to cool to below about 90° C. Then, the composition was again reintroduced to the mixer along with the ingredients identified for the “final mix stage,” which took place at 40 rpm and a peak compositional temperature of about 100° C. was achieved.

As should be evident from Tables III and IV, the type of SBR employed in each example changed according to the polymers from the above examples. The specific SBR (i.e. the polymer from the above samples) are specified in Table IV along with the results of dynamic testing that was performed on the rubber formulations or resulting vulcanizates.

TABLE III

| Ingredient | phr |
|---|---|
| Master | |
| SBR (type variable) | 100 |
| Wax | 2 |
| Silica | 52.5 |
| Carbon Black | 7 |
| Oil | 10 |
| Stearic Acid | 2 |
| Antidegradant | 1 |
| Remill | |
| Silica | 2.5 |
| Silane Coupling Agent | 5 |
| Final | |
| Zinc Oxide | 2.5 |
| DPG | 1.4 |
| MBTS | 2 |
| TBBS | 0.7 |
| Sulfur | 1.5 |

With regard to the data in Table III, the dynamic rheological properties (e.g. tan 8 and G′) of the vulcanizates were obtained from temperature sweep studies that were conducted over the range from about −80° C. to about 80° C. and 10 Hz and strain sweep studies that were conducted over the range from 0.05 to about 7.5% strain with increments of 0.25%.

TABLE IV

| | Example | Example | Example | Example | Example | Example | Example | Example |
|---|---|---|---|---|---|---|---|---|
| | 9 | 10 | 11 | 12 | 13 | 14 | 15 | 16 |
| Polymer Example | 1 | 2 | 3 | 4 | 5 | 6 | 7 | 8 |
| PEG Branch (wt %) | Na | 1.6 | 2.2 | 2.5 | 1.7 | 3.4 | 5.4 | 6.1 |

Dynamic Property

| | | | | | | | | |
|---|---|---|---|---|---|---|---|---|
| RR | 100 | 105 | 122 | 118 | 108 | 133 | 138 | 151 |
| (tan δ at 60° C.) | | | | | | | | |
| CC | 100 | 108 | 106 | 113 | 78 | 75 | 71 | 70 |
| (G′ at 30° C.) | | | | | | | | |
| M200 | 6.76 | 7.31 | 7.31 | 6.79 | 6.90 | 7.66 | 6.95 | 7.44 |

Various modifications and alterations that do not depart from the scope and spirit of this invention will become apparent to those skilled in the art. This invention is not to be duly limited to the illustrative embodiments set forth herein.

1. A tire tread comprising:
the vulcanized residue of a vulcanizable composition including
(i) a poly(alkylene oxide) grafted polydiene or polydiene copolymers;
(ii) a natural or synthetic elastomer;
(iii) silica filler; and
(iv) a curative, where the poly(alkylene oxide) grafted polydiene or polydiene copolymers includes a sulfur or methacrylate linkage between a polydiene or polydiene copolymer chain and a poly(alkylene oxide) chain.

2. The tire tread of claim 1, where the polydiene or polydiene copolymer chain is poly(styrene-co-butadiene).

3. The tire tread of claim 1, where poly(alkylene oxide) chain is a poly(ethylene oxide) chain.

4. The tire tread of claim 1, where poly(alkylene oxide) chain has a molecular weight of from about 250 to about 5000 g/mole.

5. The tire tread of claim 1, where poly(alkylene oxide) chain has a molecular weight of less than 1000 g/mole.

6. The tire tread of claim 1, where poly(alkylene oxide) chain has less than 20 repeat units.

7. The tire tread of claim 2, where the poly(styrene-co-butadiene) is characterized by a vinyl content of greater than 20%, and a bound styrene content of from about 20 to about 50 wt %.

8. (canceled)

9. The tire tread of claim 1, where the poly(alkylene oxide) grafted polydiene or polydiene copolymer includes from about 1 to about 10 wt % poly(alkylene oxide).

10. The tire tread of claim 1, where the vulcanizable composition includes greater than 50 parts by weight silica per 100 parts by weight rubber.

11. The tire tread of claim 1, where the tire tread includes a rubber component, and where the rubber component includes greater than 50 wt % of the poly(alkylene oxide) grafted polydiene or polydiene.

12. A method for preparing a poly(alkylene oxide) grafted polydiene or polydiene copolymer, the method comprising:
(i) providing a polydiene or polydiene copolymer;
(ii) providing an end-functionalized poly(alkylene oxide);
(iii) combining the polydiene or polydiene copolymer with the end-functionalized poly(alkylene oxide) within a solvent; and
(iv) allowing the polydiene or polydiene copolymer to react with the end-functionalized poly(alkylene oxide) in the presence of a free-radical initiator to thereby form a poly(alkylene oxide) grafted polydiene or polydiene copolymer including a polydiene or polydiene copolymer with a one or more poly(alkylene oxide) chains grafter thereto.

13. The method of claim 12, where the end-functionalized poly(alkylene oxide) is one of a thiol end-functionalized poly(ethylene oxide) or a methacrylate end-functionalized poly(ethylene oxide).

14. (canceled)

15. The method of claim 12, where the polydiene or polydiene copolymer chain is poly(styrene-co-butadiene).

16. The method of claim 12, where poly(alkylene oxide) chain is a poly(ethylene oxide) chain.

17. The method of claim 12, where poly(alkylene oxide) chain has a molecular weight of from about 250 to about 5000 g/mole.

18. The method of claim 12, where poly(alkylene oxide) chain has a molecular weight of less than 1000 g/mole.

19. The method of claim 12, where poly(alkylene oxide) chain has less than 20 repeat units.

20. The method of claim 15, where the poly(styrene-co-butadiene) is characterized by a vinyl content of greater than 20%.

21. The method of claim 15, where the poly(styrene-co-butadiene) is characterized by a bound styrene content of from about 20 to about 50 wt %.

22. The method of claim 12, where the poly(alkylene oxide) grafted polydiene or polydiene copolymer includes from about 1 to about 10 wt % poly(alkylene oxide).
